(19) United States
(12) Patent Application Publication
(10) Pub. No.: US 2011/0115706 A1
(43) Pub. Date: May 19, 2011

(54) Apparatus and method for providing pointer control function in portable terminal

(75) Inventors: Jeong-Sik In, Yongin-si (KR); Yong-Suk Park, Seoul (KR); Tae-Shik Shon, Suwon-si (KR); Tae-Won Ahn, Cheonan-si (KR); Bon-Hyun Koo, Suwon-si (KR)

(73) Assignee: Samsung Electronics Co., Ltd., Suwon-si (KR)

(21) Appl. No.: 12/927,241

(22) Filed: Nov. 10, 2010

(30) Foreign Application Priority Data
Nov. 13, 2009 (KR) 10-2009-0109570

(51) Int. Cl. G09G 5/08

(52) U.S. Cl. 345/158

(57) ABSTRACT

An apparatus and a method for controlling a pointer output at a peripheral device using a portable terminal. In particular, an apparatus and method for controlling a pointer on a peripheral device screen using the portable terminal and shifting an object selected using the pointer to another peripheral device, including a pointer management unit to select information on a pointer to be used and transmit the information to a peripheral device, and determine a motion position of the pointer and provide the motion position to the peripheral device.

### CROSS-REFERENCE TO RELATED APPLICATION(S) AND CLAIM OF PRIORITY

This application claims priority under 35 U.S.C. §119 of a Korean patent application filed in the Korean Intellectual Property Office on Nov. 13, 2009 and assigned Serial No. 10-2009-0109570, the entire disclosure of which is hereby incorporated by reference.

### TECHNICAL FIELD OF THE INVENTION

The present invention relates generally to an apparatus and method for controlling a pointer output of a peripheral device using a portable terminal, and in particular, to an apparatus and a method configured to control a screen of a peripheral device using the portable terminal and move an object selected using the pointer to another peripheral device.

### BACKGROUND OF THE INVENTION

With the recent rapid development of a portable terminal, a portable terminal configured for wireless voice calls and information exchange becomes a commodity. The portable terminal is capable of carrying a wireless call, but with the technology development and introduction of a wireless internet, the portable terminal has been further expanded in its use range to include games, remote controls using a near field communication, image photographs by a mounted digital camera as well as simple telephone call or schedule management purposes, thus satisfying user's demands.

Recently, the number of computers has expanded, and the amount of information has swiftly grown due to internet growth, and the computer is operated by an input control command. As control command inputs to operate the computer, a keyboard and a mouse are frequently used.

The mouse is an input device used for moving a pointer on a screen of the computer, such that a user straightforwardly approaches data existing at a desired position.

Different means of controlling a pointer movement as described above include a trackball and a touch pad; these may be provided for one computer.

For such a reason, when a user uses a corresponding input device where a number of computers exist, the problem exists that the user needs to connect a corresponding input device directly to a computer to be used, but does not have a function for controlling interworking with the portable terminal.

Also, since the input device may not operate among a multiple of computers, it is possible to separately control each connected computer but a process of interworking more than two computers (similar to the way a file moves between computers) may not be available.

Therefore, an apparatus and method for frequent interworking between a portable terminal and a computer is needed.

### SUMMARY OF THE INVENTION

To address the above-discussed deficiencies of the prior art, one aspect of the present invention is to provide an apparatus and a method for controlling a pointer of peripheral devices using a portable terminal.

Another aspect of the present invention is to provide an apparatus and method capable of an object motion between peripheral devices using a portable terminal.

Still another aspect of the present invention is to provide an apparatus and method for determining an input pointer position of multiple peripheral devices using a screen photographed at a portable terminal.

In accordance with an aspect of the present invention, an apparatus for providing a pointer function at a portable terminal includes a pointer management unit configured to select information on a pointer to be used and transmit the same to peripheral devices, and determine a motion position of the pointer and provide it to the peripheral devices.

In accordance with another aspect of the present invention, a method of providing a pointer function at a portable terminal includes selecting information on a pointer to be used and transmitting the same to peripheral devices and determining a motion position of the pointer and providing it to the peripheral devices.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a construction of a mobile communication system for providing a pointer function according to the invention;

FIG. 2 illustrates a process of controlling a pointer displayed on a monitor of peripheral devices at a portable terminal according to the present invention;

FIG. 3 illustrates a process of registering a pointer to peripheral devices in a portable terminal according to an embodiment of the present invention;

FIG. 4 illustrates a process of determining a pointer position correction value at a portable terminal according to an embodiment of the present invention;

FIG. 5 illustrates a process of connecting to multiple peripheral devices at a portable terminal according to an embodiment of the invention;

FIG. 6 illustrates a process of correcting the position of an output pointer at a peripheral device according to an embodiment of the present invention;

FIG. 7 illustrates a process of controlling multiple peripheral devices at a portable terminal according to one embodiment of the invention;

FIG. 8 illustrates a process of editing objects through use of a pointer at a portable terminal according to another embodiment of the invention;

FIG. 9 illustrates a process of editing objects at peripheral devices according to another embodiment of the invention;

FIG. 10 illustrates a process of requesting an object editing at peripheral devices according to another embodiment of the invention;

FIG. 11 illustrates a process of editing an object using a portable terminal according to another embodiment of the invention; and

FIG. 12 illustrates a process of editing an object using a portable terminal according to yet another embodiment of the invention.

Throughout the drawings, like reference numerals will be understood to refer to like parts, components and structures.

### DETAILED DESCRIPTION OF THE INVENTION

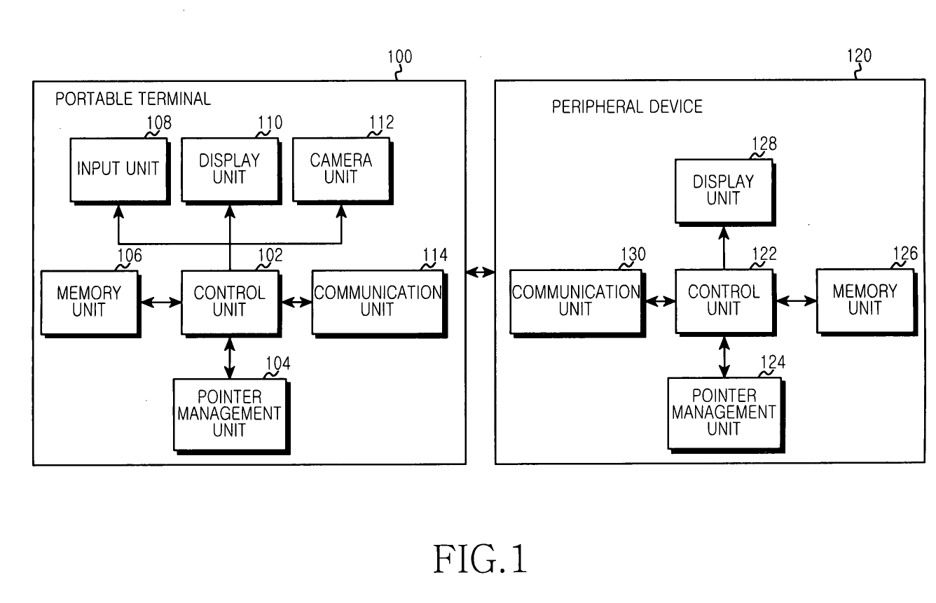

FIGS. 1 through 12, discussed below, and the various embodiments used to describe the principles of the present disclosure in this patent document are by way of illustration only and should not be construed in any way to limit the scope of the disclosure:

In the following description, an apparatus and a method for controlling a pointer of multiple peripheral devices using a portable terminal and moving a selected object to other peripheral devices according to the pointer control in accordance with the invention will be described.

In the following description, the portable terminal refers to a pointer device for controlling a pointer output on a screen of peripheral devices, all including terminals controlling an outputted pointer such as a mobile terminal, and a remote control, a camera, a personal digital assistant (PDA). The following description will be presented with a general construction of a portable terminal. Thus, a portable terminal of the present invention might not be limited to a mobile terminal.

FIG. 1 illustrates a construction of a mobile communication system for providing a pointer function according to an embodiment of the present invention.

As shown in FIG. 1, the mobile communication system may be configured to include a portable terminal 100 and a peripheral device 120. The portable terminal 100 may be constructed to include a control unit 102, a pointer management unit 104, a memory unit 106, an input unit 108, a display unit 110, a camera unit 112 and a communication part 114.

A control unit 102 of the portable terminal 100 controls a general operation of the portable terminal 100. For example, control unit 102 performs a process and control for voice call and data communication. In addition to normal operation, the control unit 102 sets a pointer to be used by communicating with the peripheral device 120 for pointer control, and controls processes to move the set pointer to a user desired position according to the present invention. Also, the control unit 102 moves the pointer towards a screen of multiple peripheral devices. In addition to a movement of the pointer, the control unit 102 processes an object editing function moving a selected object to another peripheral device 120.

The pointer management unit 104 manages processes to provide a position of a pointer to be moved by a user to a peripheral device 120 according to a direction of the control unit 102 in order to enable the peripheral device to shift an output pointer. Because a distance of movement recognized by the portable terminal 100 is different from a distance according to screen pixels of the peripheral device 120, the pointer management unit 104 converts the recognized distance of movement to a corresponding distance according to screen pixels of the peripheral device 120.

The pointer management unit 104 determines if the pointer is moved to a screen of another peripheral device by analyzing a screen photograph of a pointer output at the peripheral device 120, and when a movement to a screen of the other peripheral device is determined, it manages a process to perform a communication connection with a corresponding peripheral device 120 to conduct a continuous pointer function.

When a user of the portable terminal 100 selects a specific object to edit an object, the pointer management unit 104 receives information of the selected object from a pre-connected peripheral device 120, i.e., a previous peripheral device, and transmits it to another peripheral device for editing of the object. The previous peripheral device is a pre-connected peripheral device before the portable terminal is connected to a peripheral device, namely, a peripheral device storing the object.

The memory unit 106 includes, for example, a ROM, a RAM, a flash ROM, and the like. The ROM stores a microcode (i.e., code) of a program and each kind of reference data for process and control of the control unit 102 and the pointer management unit 104.

The RAM is a working memory of the control unit 102, storing temporary data occurring during each kind of program execution. The flash ROM stores a telephone book, and each type of updatable storage data such as an originating message and a terminating message.

The input part 108 includes multiple functional keys, such as 0-9 number key buttons, a menu button, a cancel button, a confirm button, a call button, an end button, an internet access button, navigation key buttons and a character input key, and provides key input data corresponding to a key pressed by a user (e.g., pointer function execution) to the control unit 102.

The display unit 110 displays status information, characters, moving images and still images produced during operation of the portable terminal 100, and such. The display unit 110 can be a color Liquid Crystal Display (LCD), an Active Mode Organic Light Emitting Diode (AMOLED), and the like. The display unit 110 may include a touch input apparatus to be used as an input apparatus when applying to a portable terminal 100 having a touch input mode.

The camera unit 112 is placed at the front surface of the portable terminal 100 to take a photograph of a direction indicated by the portable terminal 100. That is, the camera unit 112 photographs a direction where the pointer should be positioned. Also, the camera unit photographs a screen to determine a peripheral device the pointer has moved to, when a pointer output at the peripheral device 120 moves to another peripheral device.

The communication unit 114 performs a function of transmitting/receiving a radio signal of data input/output via an antenna (not illustrated). For example, for transmission, the communication unit 114 performs channel coding and spread of transmitted data and then an RF processing for transfer. In data reception, the communication unit 114 conducts a function of restoring data by converting a received RF signal to a base band signal and dispreading and channel decoding the base band signal. The communication unit 114 transmits object editing-purpose information and pointer position correction information according to the present invention.

The peripheral device 120 may be constructed to include a control unit 122, a pointer management unit 124, a memory unit 126, a display unit 128, and a communication unit 130.

A control unit 122 of the peripheral device 120 controls a general operation of the peripheral device 120. For example, the control unit 122 performs a process and control for application program and data communication. In addition to a normal operation, the control unit 122 controls processes to register a pointer to communicate with the portable terminal 100 for pointer control and move the registered pointer to a user desired position according to the present invention.

The pointer management unit 124 provides a pointer format usable at a pointer registration of the portable terminal 100 at a direction of the control unit 122 to the portable terminal 100, and provides pointer information registered at the peripheral device 120 to the portable terminal 100 for searching a peripheral device that output a pointer of the portable terminal 100

The pointer management unit 124 manages processes to perform an object editing with the previous peripheral device by requesting a previous peripheral device in which the object exists, when it receives object information from the portable terminal 100.

The pointer management unit 124 periodically receives a position correction value of a pointer from the portable terminal 100 and moves the output pointer by a camera of the portable terminal 100 to a middle of an output screen, when connected with the portable terminal 100.

The memory unit 126 stores a microcode of a program and each kind of reference data for process and control of the control unit 200 and the pointer management unit 202, and stores format information of a pointer used in the portable terminal 100 according to the present invention.

The display unit 128 displays status information, characters, and moving images and still images produced during operation of the portable terminal 100. The display unit 128 may use a color liquid display device and the display unit 110 may use a color liquid display device. The display unit 128 may include a touch input apparatus to be used as an input apparatus for a touch input mode. The display unit 128 outputs a pointer corresponding to the portable terminal 100 according to the invention.

The communication unit 130 receives object editing information and pointer position correction information according to the invention, and transmits format information of a pointer to be set at the portable terminal 100.

While a role of the pointer management unit 104, 124 of the portable terminal 100 and the peripheral device 120 may be performed by the control unit 102, 122, they are shown separately as an example configuration for the sake of convenience but not in a sense of limiting the scope of the present invention. It would be understood by a person in the art that various modifications can be made in keeping with the spirit of the invention. For example, all of functions of the pointer management unit 104, 124 can be configured to be processed by the control unit 102, 122.

Thus, an apparatus for controlling a pointer of a peripheral device using a portable terminal according to the present invention, and for moving a selected object according to the pointer control to another peripheral device has been described. In the following description, a method of controlling a pointer of the peripheral device using the above apparatus according to the invention will be described.

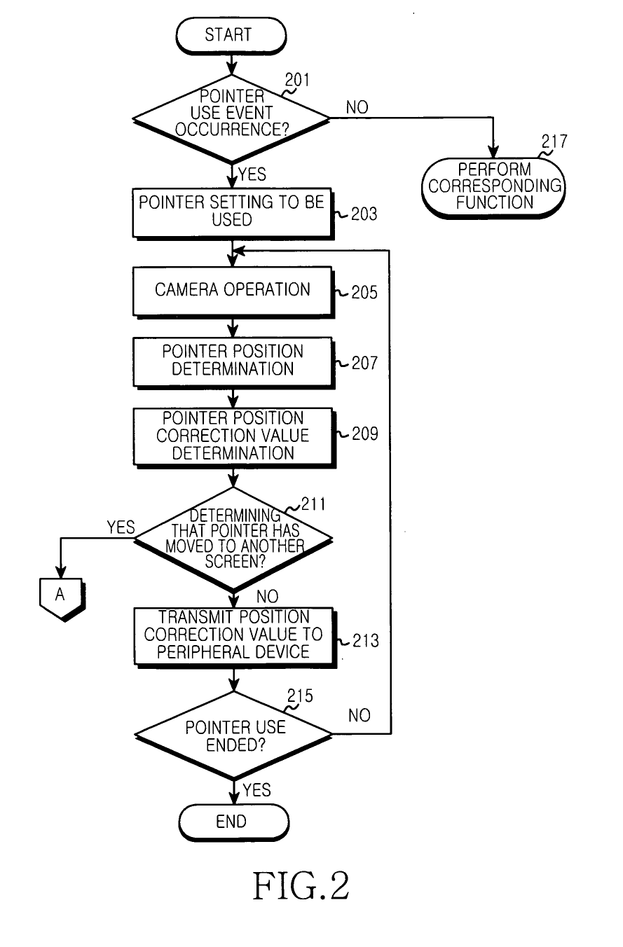

FIG. 2 illustrates a process of controlling a pointer displayed at a monitor of a peripheral device at a portable terminal according to an embodiment of the present invention.

As shown in FIG. 2, the portable terminal first determines if a pointer use event occurs in block 201. Herein, the pointer use event refers to an event for controlling a point output at a peripheral device (e.g., a personal computer, a beam projector, and the like) using the portable terminal.

If it is determined that the pointer use event does not occur in the block 201, the portable terminal proceeds to block 217 to perform a corresponding function (e.g., a standby mode).

If it is determined that the pointer use event occurs in the block 201, the portable terminal proceeds to block 203 to set a to-be-used pointer. Here, the to-be-used pointer sets a pointer corresponding to the portable terminal, and it may be the color, shape, and size of a pointer.

Thereafter, the portable terminal proceeds to block 205 and operates a camera to take a photograph of a screen of the peripheral device and a pointer output on the screen of the peripheral device, and after that, proceeds to block 207 to determine a position of a pointer.

Determining a position of the pointer is for the purpose of locating the pointer at a medium position of a screen output using the camera by determining a deviated distance from a medium position of the screen.

Thereafter, the portable terminal proceeds to block 209 and determines a pointer position correction value. The pointer position correction value refers to a movement value to locate the position of a current outputted pointer with respect to a screen center photographed by the camera.

A portable terminal that determined a pointer position correction value as described above proceeds to block 211 and determines if the output pointer is moved to a screen of a peripheral device placed at its surrounding.

Herein, a fact that the output pointer has moved to a screen of a peripheral device placed at the surrounding means that a user of the portable terminal relocates the portable terminal to a peripheral device and photographs a screen of a peripheral device, so that when the portable terminal receives and determines a message informing of a pointer deviation from the peripheral device (a message informing that the pointer has moved to another peripheral device), or a screen of a peripheral device is different from the photographed screen, the portable terminal may determine the pointer deviation. A portable terminal determining a pointer deviation described above cancels a communication connection with an output peripheral device prior to a deviation of the pointer, thereby disallowing the transfer of information periodically transmitted to the peripheral device.

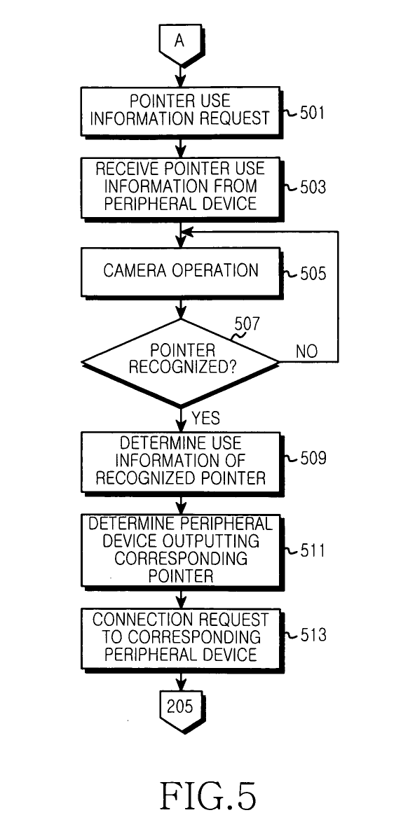

If it is determined that the output pointer has moved to a screen of a peripheral device placed at the surrounding in block 211, the portable terminal performs a process as described in FIG. 5, and thus performs a process of connecting to a peripheral device of the pointer moved screen. A process connected to the peripheral device will be explained in detail at FIG. 5 below.

When it is determined that the output pointer has not moved to a screen of a peripheral device placed at the surrounding in block 211, the portable terminal proceeds to block 213 and transmits a position correction value for moving a location of the output pointer toward a center of the photographed screen of the peripheral device.

Thereafter, the portable terminal proceeds to block 215 and determines if a pointer use finish is sensed.

If a pointer use finish is not sensed in block 215, the portable terminal proceeds to block 205 and repeats the process of locating a pre-output pointer at a center of a screen photographed through the camera.

When a pointer use finish is sensed in the block 215, the portable terminal ends the current algorithm.

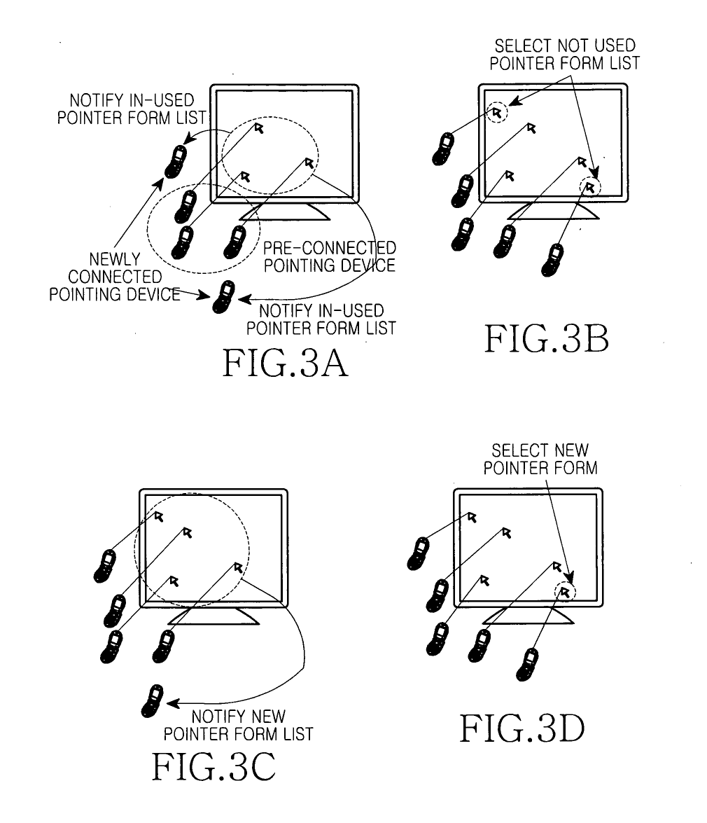

FIG. 3A-3D are diagrams illustrating a process of registering a pointer to a peripheral device at a portable terminal according to an embodiment of the present invention.

A peripheral device to which the portable terminal registers a pointer can support a pointer of multiple portable terminals.

The portable terminals may each set a different form of pointer to distinguish from a pointer of another portable terminal.

For example, as shown in FIG. 3A, assuming that there exist three portable terminals pre-connected to the peripheral device, and two other portable terminals in the surrounding area, the peripheral device transmits information on the forms of the currently set pointers or on a currently unused pointer form to the two surrounding portable terminals.

A portable terminal that has received information on a pointer form as described above registers a pointer by selecting a form of a pointer unused by the pre-connected portable terminals as shown in FIG. 3B.

If two portable terminals that have not registered a pointer simultaneously register a same form of a pointer, the peripheral device sets a corresponding pointer for a portable terminal according to a priority and re-transmits information of the settable pointer at a portable terminal having a low priority. The priority may be set based on a pointer setting request order or a user assigned order.

And thus, a portable terminal having a low priority communicates with the peripheral device as shown in FIG. 3D to select a form of a pointer unused by other portable terminals for pointer registration, so that each of the portable terminals sets a different pointer to distinguish its own pointer.

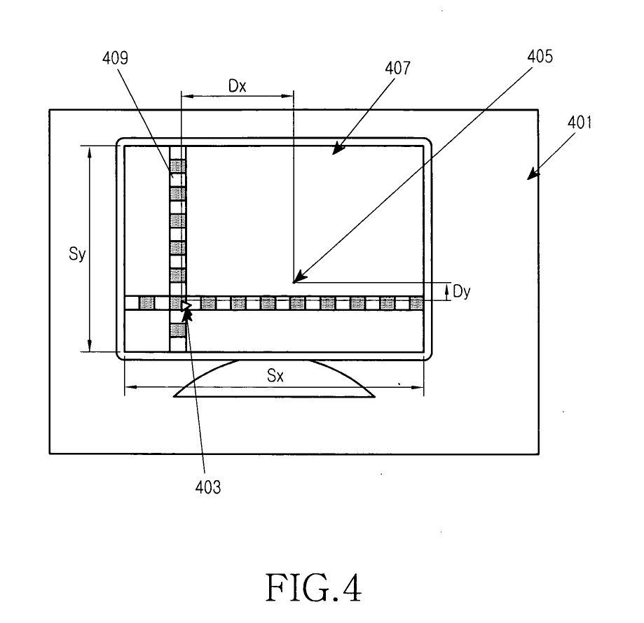

FIG. 4 illustrates a process of determining a pointer position correction value at a portable terminal according to an embodiment of the present invention.

As shown in FIG. 4, when the portable terminal first sets and notifies a pointer to be used by itself to a peripheral device, the peripheral device will output a pointer 403 corresponding to an embodiment of the portable terminal.

The portable terminal is configured to photograph a screen of the peripheral device and determine a center 405 of the photographed screen 401 to be a pointer located position to correct a position of the output pointer.

When the portable terminal captures a pointer on a screen photographed through a camera, it determines a position correction value that is a distance deviated from a center of the photograph screen.

The pointer is output to a peripheral device and moved around. A basis for defining a position of the pointer is a screen of a camera (a position of a pointer is a corrected value based on a screen photographed by a camera), but when the peripheral device receives the correction value, it may be impossible to determine a correction to a precise position. In such as case, the portable terminal may measure a location of a pointer relocated by the peripheral device as a correction value based on pixel units.

In order to measure based on pixel units of a peripheral device as described above, the portable terminal analyzes a screen output as a pattern of a defined shape, size, and color by the peripheral device and thus determines pixels of the peripheral device screen when at first connected to the peripheral device.

For example, the portable terminal outputs a lattice 409 in the shape of a cross form configured with two colors at a pixel interval defined at a screen 407 of a peripheral device around a pointer outputted through the camera, and determines pixels of the peripheral device screen.

Such a method does not cover an entire screen of the peripheral device on a photographed screen of the portable terminal, but can at any time determine a ratio of a desired pixel number when including the pointer.

A portable terminal which determines pixels of a peripheral device screen as described above transforms a distance in which a currently output pointer needs to move into a center of a photographed screen based on pixels of the peripheral device and transmits it to the peripheral device.

That is, the portable terminal transforms a position of a pointer deviated from a center of a photographed screen, such that the peripheral device can locate a corresponding pointer in a center of the photographed screen.

FIG. 5 illustrates a process of connecting to multiple peripheral devices at a portable terminal according to an embodiment of the present invention.

As shown in FIG. 5, it is assumed that the portable terminal first performs a pointer function by communicating with any one peripheral device among multiple peripheral devices.

The portable terminal requests pointer use information of peripheral devices in block 501. The pointer use information refers to information of pointers allowed to portable terminals by each of peripheral devices.

Thereafter, when the portable terminal proceeds to block 503 and receives pointer information corresponding to the request from the peripheral devices, it stores the received pointer information and then proceeds to block 505 and operates a camera and photographs a screen of a peripheral device existing in a direction indicated by the portable terminal.

Thereafter, the portable terminal proceeds to block 507 and analyzes a screen photographed at block 505 and determines whether the screen recognizes a pointer.

If a pointer is not recognized in the block 507, the portable terminal proceeds to block 505 and re-performs a process of determining a peripheral device indicated by the portable terminal.

When a pointer is recognized in block 507, the portable terminal proceeds to block 509 and determines the form of the recognized pointer and compares it to the pointer use information received and stored in the block 503.

Thereafter, the portable terminal proceeds to block 511 and determines a peripheral device that output the recognized pointer. That is, the portable terminal determines at which peripheral device a pointer is used (determines a peripheral device outputting the pointer) using the pointer recognized in block 509 and pre-stored pointer use information.

Thereafter, the portable terminal proceeds to block 513 and performs a communication connection request to the peripheral device determined in block 511, thereby making a pointer control between the peripheral devices possible.

Thereafter, the portable terminal proceeds to block 205 of FIG. 2 and performs a process of correcting a position of the pointer.

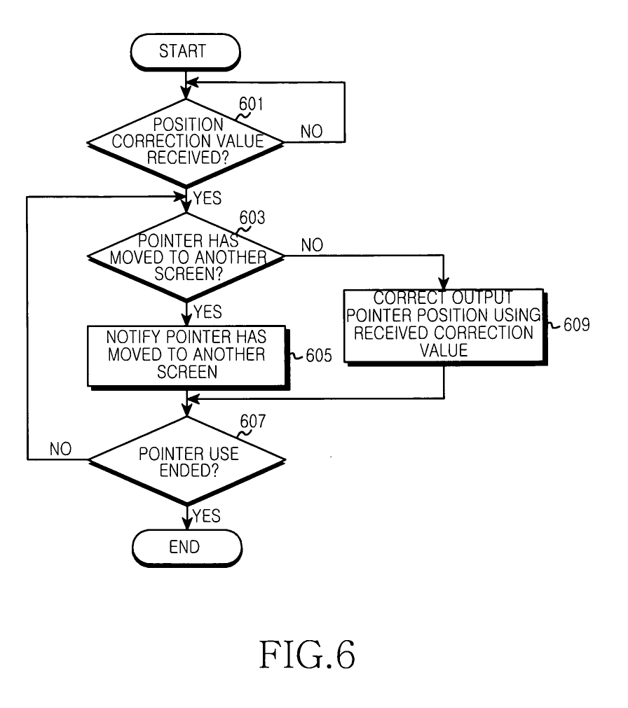

FIG. 6 illustrates a process of correcting a position of an output pointer at a peripheral device according to an embodiment of the invention.

As shown in FIG. 6, the peripheral device firstly determines whether a position correction value, that is, a value for correcting a location of a pointer being output from the portable terminal, is received in block 601.

If a position correction value is not received in block 601, the peripheral device re-performs the process of block 601.

If a position correction value is received in block 601, the peripheral device proceeds to block 603 and determines if a pointer relocated to a screen of another peripheral device. If it is determined that the output pointer moved out of a screen or a pointer is not output for a certain time, the peripheral device may determine that a pointer has moved to a screen of the other peripheral device.

If it is determined that the pointer has not moved to a screen of another peripheral device in the block 603, the peripheral device proceeds to block 609 and corrects a position of an output pointer using a position correction value received from a portable terminal.

If it is determined that the pointer has moved to a screen of another peripheral device in block 603, the peripheral device proceeds to block 605 and notifies the portable terminal that a pointer has relocated to a screen of another peripheral device.

Thereafter, the peripheral device proceeds to block 607 and determines if a pointer use finish is received from the portable terminal.

If a pointer used finish is not received in block 607, the peripheral device proceeds to the block 603 and corrects a position of an output pointer not relocated to a screen of the other peripheral device using a position correction value received from the portable terminal.

When a pointer used finish is received in the block 607, the peripheral device ends the current algorithm.

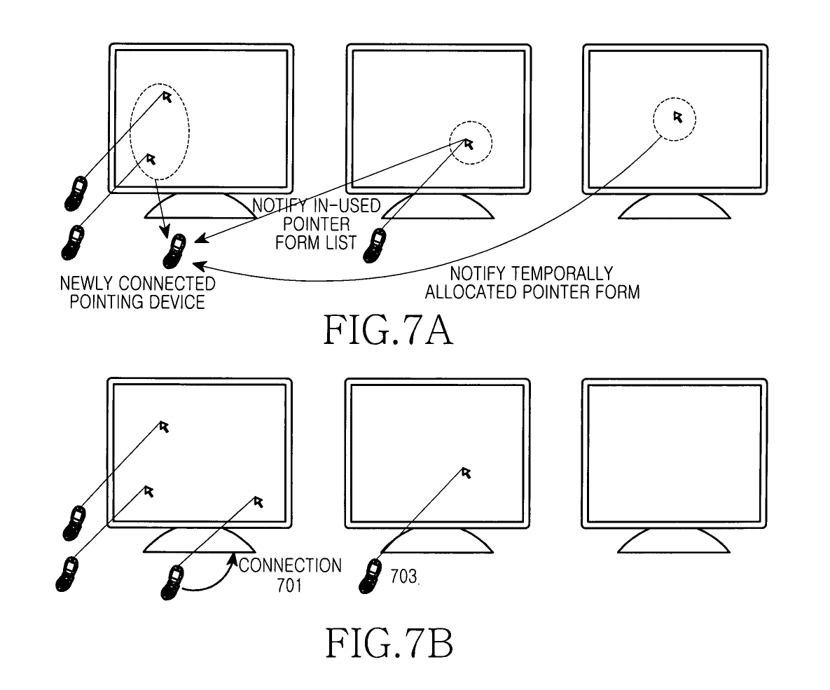

FIGS. 7A and 7B illustrate a process of controlling multiple peripheral devices at a portable terminal according to an embodiment of the invention.

As shown in FIGS. 7A and 7B, two portable terminals use a pointer communicating with any one peripheral device of multiple peripheral devices existing in a surrounding.

Thereafter, when a portable terminal not already registered intends to register a new pointer, the peripheral devices provides information in a used pointer form and allows the new portable terminal to set a pointer of any form different from a pointer already used by another portable terminal.

When a pointer of a portable terminal performing a pointer setting as described above has moved to a screen of another peripheral device, peripheral devices transmit information of a pointer allocated to the peripheral device to the portable terminal as shown in FIG. 7A. When a peripheral device is not registered with a pointer, a peripheral device allocates any pointer directly, and transmits information of the allocated pointer form to the portable terminal.

Thus, a portable terminal receiving information of the pointer form may determine a form of a pointer used at each peripheral device. Pointers set to peripheral devices may each have a different form, and the form of a pointer may be used as information for determining a peripheral device outputting a pointer.

A portable terminal receiving pointer form information as described above recognizes (701) a pointer at a photographed screen as shown in FIG. 7B to determine a peripheral device to which the pointer has relocated.

If the portable terminal recognizes any one pointer among multiple pointers, the portable terminal notes the form of the pointer existing on a photographed screen, and compares the form of the recognized pointer with information of the received pointer form.

That is, the portable terminal may determine a peripheral device outputting a recognized pointer by comparing the form of a pointer recognized at a photographed screen with information of a received pointer form.

For example, if information of a pointer form is received informing that a first peripheral device uses a red pointer and a second peripheral device uses a white pointer, and a red pointer is recognized at a photographed screen, the portable terminal may determine (703) that a currently photographed screen is a first peripheral device and thus determine that the pointer is moving to a screen of a first peripheral device.

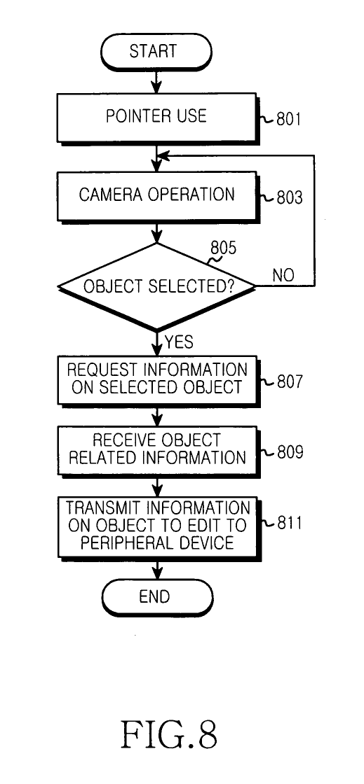

FIG. 8 illustrates a process of editing objects through a pointer use at a portable terminal according to another embodiment of the invention.

As shown in FIG. 8, the portable terminal first performs a function of using a pointer connecting to a peripheral device in block 801, and then proceeds to block 803 and operates a camera.

Thereafter, the portable terminal proceeds to block 805 and determines if an object is selected. Here, the object is data executed by a specific application program running on the peripheral device, meaning a specific file, a specific folder, and the like. Object editing, described hereinafter, indicates a process of assigning a corresponding object and editing the object, such as copy, move and store. Object editing may be performed inside one peripheral device, and object editing may be possible as an editing into another peripheral device.

If it is determined that an object is not selected in block 805, the portable terminal re-performs the process of block 803.

Alternatively, when an object selection is determined in block 805, the portable terminal proceeds to block 807 and requests from the peripheral device information about the object selected in block 805. Information on the selected object includes object assigning information. For example, when the object is a specific file, the object related information may be an IP address of the specific file, a file path, a file name combination, and the like.

Thereafter, the portable terminal proceeds to block 809 and receives information requested in block 807 from the peripheral device. Afterwards, the portable terminal proceeds to block 811 and transfers from a previous peripheral device, where an object to be edited by the portable terminal exists and its stored position therein, to another peripheral device by transmitting the received information, that is, information on an object to be edited, to the other peripheral device in a surrounding.

Here, the other peripheral device refers to a peripheral device determined as described in FIG. 5, that is, another peripheral device to which the portable terminal intends to connect.

Thereafter, the portable terminal ends the current algorithm.

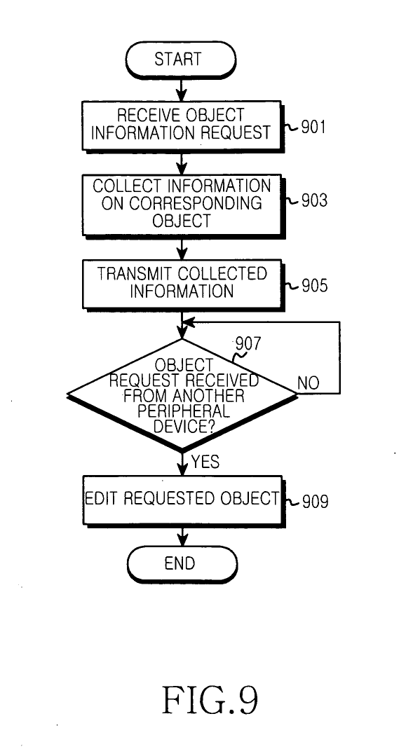

FIG. 9 illustrates a process of editing objects at a peripheral device according to another embodiment of the invention.

As shown in FIG. 9, the peripheral device first receives an object information request from a portable terminal in block 901, and then proceeds to block 903 and collects information on a corresponding object.

That is, when the peripheral device, for example, receives an object information request, it determines an object assigned by a pointer of an output portable terminal, and collects information about the determined object (e.g., a file name of a corresponding object, a stored position, and the like.).

Thereafter, the peripheral device proceeds to block 905 and transmits the object information collected at the block 903 to the portable terminal.

Thereafter, the peripheral device proceeds to block 907 and determines if an object request from another peripheral device existing in a surrounding is received. Here, the object request is that an object selected to edit by the portable terminal is requested at another peripheral device to which a pointer moved.

If an object request is not received in block 907, the peripheral device determines an object request reception or not by re-performing a process of the block 907.

If an object request is received in the block 907, the peripheral device proceeds to block 909 and performs a process of editing a corresponding object.

Here, an object editing conducted by the peripheral device refers to an editing process that, for example, moves, shifts, and stores an object selected by the portable terminal into a peripheral device requesting the object.

Thereafter, the peripheral device ends the current algorithm.

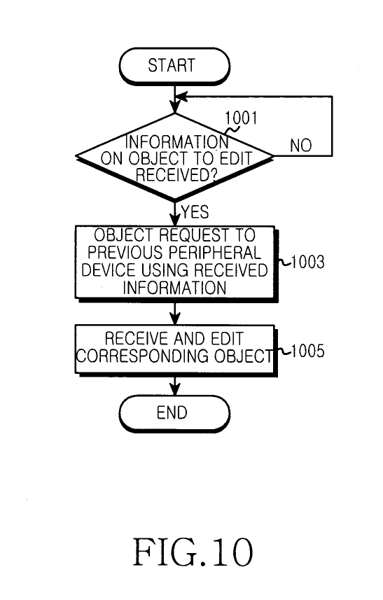

FIG. 10 illustrates a process of requesting an object editing at a peripheral device according to another embodiment of the present invention.

As shown in FIG. 10, the peripheral device first determines if information on an object to be edited is received in block 1001. Here, the information on the object to be edited is information transmitted by a portable terminal, acting to assign an object selected for editing by the portable terminal.

If information on an object to be edited in the block 1001 is not received, the peripheral device re-performs a process of the block 1001 and determines an object information reception or not.

If information on an object to be edited in the block 1001 is received, the peripheral device proceeds to block 1003 and requests a previous peripheral device of an object. Herein, the previous peripheral device refers to a peripheral device previously connected to the portable terminal before the portable terminal was connected to a current peripheral device and previously storing the object.

Thereafter, the portable terminal proceeds to block 1005 and receives and edits a corresponding object, and then ends the current algorithm.

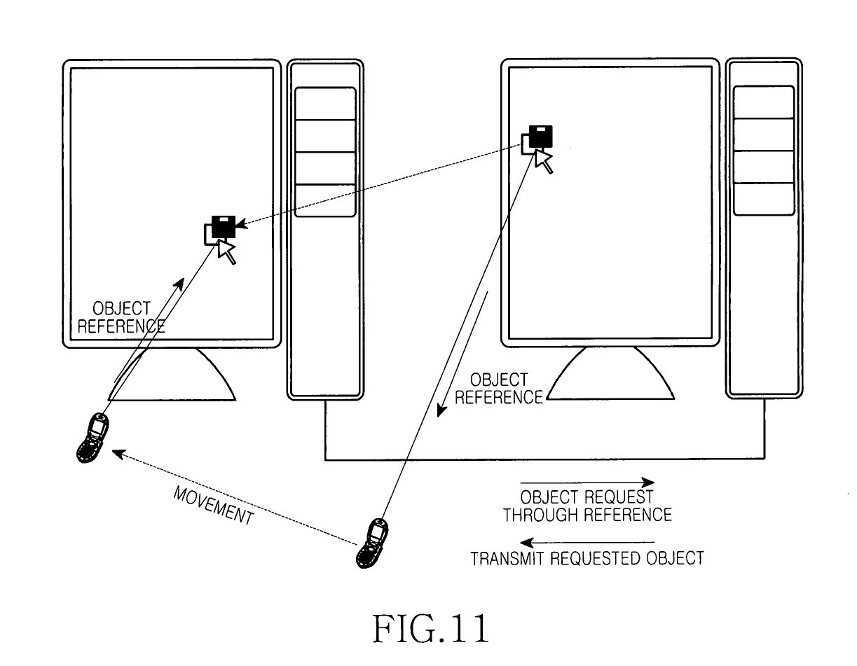

FIG. 11 illustrates a process of editing an object using a portable terminal according to another embodiment of the present invention.

As shown in FIG. 11, the portable terminal (a first terminal) sets a pointer connecting to a peripheral device (a first peripheral device), and the peripheral device (the first peripheral device) connected to the portable terminal (the first terminal) outputs a corresponding pointer. Also, there exists another peripheral device (a second peripheral device) connected by a network in the vicinity of the peripheral device (the first peripheral device). A user of the portable terminal (the first terminal) performs an editing process of moving an object between peripheral devices (the first peripheral device, the second peripheral device) using the portable terminal (the first terminal).

To perform the above described editing process, the portable terminal (the first terminal) selects a specific object using an output pointer.

The peripheral device (the first peripheral device), determining that a specific object is selected as described above, transmits information on the selected object to the portable terminal (the first terminal).

Thereafter, the portable terminal (the first terminal) communicates by relocating the output pointer to a screen of another peripheral device (the second peripheral device), and then transmits information on the object received from the previous peripheral device (the first peripheral device) to the other peripheral device (the second peripheral device).

The other peripheral device that received the object information (the second peripheral device) transmits received object information to the previous peripheral device (the first peripheral device) and the previous peripheral device (the first peripheral device) transmits the corresponding object using the information.

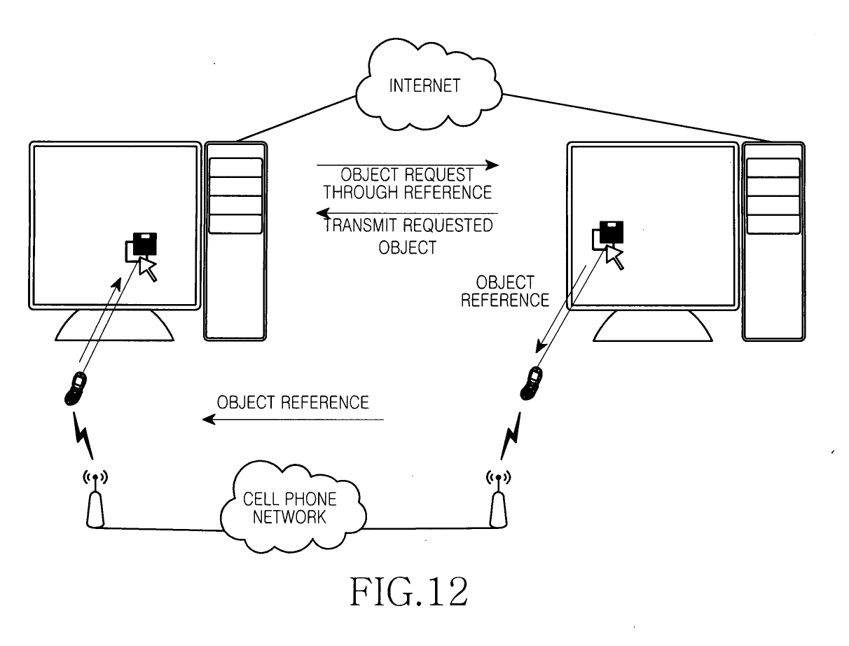

FIG. 12 illustrates a process of editing an object using a portable terminal according to still another embodiment of the invention.

As shown in FIG. 12, the portable terminal (a first terminal) sets a pointer connecting to a peripheral device (a first peripheral device), and the peripheral device (the first peripheral device) connected to the portable terminal (the first terminal) outputs a corresponding pointer. Also, there exist another peripheral device (a second peripheral device) capable of being connected by the internet in the vicinity of the peripheral device (the first peripheral device) and another portable terminal (a second terminal) wirelessly connected to the portable terminal (the first terminal). And thus, the other portable terminal (the second terminal) outputs a corresponding pointer communicating with another peripheral device (a second peripheral device). A user of the portable terminal (the first terminal) performs an editing process of moving an object between peripheral devices using the portable terminal (the first terminal).

To perform the above described editing process, the portable terminal (the first terminal) selects a specific object using an output pointer.

The peripheral device (the first peripheral device), determining that a specific object is selected as described above transmits information on the selected object to the portable terminal (the first terminal).

Thereafter, the portable terminal (the first terminal) provides the object related information through a wireless connection (e.g., SMS) to the other portable terminal (the second terminal), and the other portable terminal (the second terminal) that received the object information provides object information to the corresponding peripheral device (the second peripheral device).

And thus, peripheral devices (the first peripheral device, the second peripheral device) request an object via an internet connection, and perform an editing process of providing a resultant object.

As described above, the present invention controls a pointer of a peripheral device using a portable terminal and processes an action relocating an object selected according to the pointer control to another peripheral device, thereby making it possible to relieve inconveniences that arise when an input device for an existing pointer control is fixed to a specific computer.

While the specification of the invention has been described with reference to certain preferred embodiments thereof, various changes may be made therein without departing from the scope of the invention. Therefore, the scope of the present invention is not limited to the described embodiment, but should be defined by the appended claims and its equivalents.

What is claimed is:

1. An apparatus for providing a pointer function at a portable terminal, comprising:
a pointer management unit configured to select information on a pointer to be used, transmit the information to a peripheral device, determine a motion position of the pointer, and provide the motion position to the peripheral device.

2. The apparatus of claim 1, wherein when the peripheral device receives the pointer related information, the peripheral device outputs a pointer corresponding to the information, and when the peripheral device receives a pointer position from a portable terminal, the peripheral device moves a pointer to a corresponding position.

3. The apparatus of claim 2, wherein the peripheral device is configured to support multiple portable terminals, each portable terminal configured to set a different form of pointer.

4. The apparatus of claim 1, wherein the pointer management unit determines a motion distance of the pointer by photographing a screen of the peripheral device, and determines a motion position of the pointer by converting the determined motion distance to a screen pixel based distance of the peripheral device.

5. The apparatus of claim 4, wherein the motion distance of the pointer is a position of a pointer spaced from a center of the screen of the photographed peripheral device.

6. The apparatus of claim 1, wherein when a pointer output on a screen of the peripheral device relocates to a screen of another peripheral device, the pointer management unit maintains a pointer function by determining and communicating with a peripheral device to which the pointer has moved.

7. The apparatus of claim 6, wherein the pointer management unit determines that the output pointer has moved to a screen of another peripheral device when a photographed screen by the portable terminal does not have a screen of a peripheral device, or by receiving from the peripheral device information telling that an output pointer has moved from a screen.

8. The apparatus of claim 6, wherein the pointer management unit receives and stores information on a used pointer from the peripheral device, compares the stored information with a pointer output on a screen of a portable terminal, and determines that a peripheral device outputting the output pointer is a peripheral device to which the pointer has relocated.

9. The apparatus of claim 8, wherein when the output pointer selects a specific object, the pointer management unit edits the object by transmitting information assigning the selected specific object to another peripheral device.

10. The apparatus of claim 9, wherein the peripheral device requests a corresponding object from a previous peripheral device in which the specific object is stored using the received information.

11. A method of providing a pointer function at a portable terminal, the method comprising:
selecting information on a pointer to be used;
transmitting the information to a peripheral device;
determining a motion position of the pointer; and
providing the motion position to the peripheral device.

12. The method of claim 11, further comprising:
outputting a pointer corresponding to the information by the peripheral device when the peripheral device receives the pointer related information; and
moving a pointer to a corresponding position by the peripheral device when the peripheral device receives a pointer position from the portable terminal.

13. The method of claim 12, wherein the peripheral device supports multiple portable terminals, each portable terminal configured to set a different form of pointer.

14. The method of claim 11, wherein the determining of a motion position of the pointer further comprises:
determining a motion distance of the pointer by photographing a screen of the peripheral device; and
converting the determined distance to a screen pixel based distance of the peripheral device.

15. The method of claim 14, wherein the motion distance of the pointer is a position of a pointer spaced from a center of a screen of the photographed peripheral device.

16. The method of claim 11, further comprising:
providing a pointer function at a portable terminal by determining and communicating with a peripheral device to which the pointer has moved when a pointer output on a screen of the peripheral device relocates to a screen of another peripheral device.

17. The method of claim 16, wherein the output pointer moving to a screen of another peripheral device is determined by receiving from the peripheral device information telling that an output pointer has moved from a screen, or when a photographed screen by the portable terminal does not have a screen of a peripheral device.

18. The method of claim 16, wherein the determining of a peripheral device to which the pointer has moved further comprises:
receiving and storing information on a used pointer from the peripheral device;
comparing the stored information with a pointer output on a screen of a portable terminal; and
determining that a peripheral device outputting the output pointer is a peripheral device to which the pointer has relocated.

19. The method of claim 11, wherein the method of providing a pointer function at a portable terminal further comprises editing the object by transmitting information assigning the selected specific object to another peripheral device, when the output pointer selects a specific object.

20. The method of claim 19, wherein the peripheral device requests a corresponding object from a previous peripheral device in which the specific object is stored using the received information.
